(19) United States
(12) Patent Application Publication
(10) Pub. No.: US 2009/0077299 A1
(43) Pub. Date: Mar. 19, 2009

(54) Method and System for Accessing Data

(75) Inventors: Pei-Feng Wang, Taipei (TW); Jia-Jen Lin, Hsinchu (TW)

Correspondence Address: GENE I. SU, XIN YI RD., SECTION 4, NO. 151, 17F-1, TAIPEI, TW

(73) Assignee: LAYERWALKER TECHNOLOGY, INC., Taipei (TW)

(21) Appl. No.: 11/855,760

(22) Filed: Sep. 14, 2007

(51) Int. Cl. G06F 13/364

(52) U.S. Cl. 710/316

(57) ABSTRACT

A method and system for accessing data are disclosed. Specifically, one embodiment of the present invention sets forth a method, which includes the steps of providing a first path for a computing device to direct a first request to access the storage device associated with the computing device, providing a second path for a master to direct a second request to access the storage device based on an operating mode associated with the computing device, and establishing a reliable communication link with the storage device prior to transmitting a command to the storage device.

### BACKGROUND OF THE INVENTION

1. Field of the Invention

Embodiments of the present invention relate generally to network and storage technologies and more specifically to a method and system for accessing data.

2. Description of the Related Art

Unless otherwise indicated herein, the approaches described in this section are not prior art to the claims in this application and are not admitted to be prior art by inclusion in this section.

With the wide adoption of the Internet and the various wireless technologies, there is also an increasing need to access information from anywhere and at any time. To access data at any time necessarily requires the storage devices containing the data to be available to respond to data requests. However, many existing storage devices on the network may not be available all the time. To illustrate, FIG. 1 is a simplified diagram of a conventional computing device 100 that is on a network 116 and also attached to a storage device 114. Suppose a remote master 118 requests to read a particular data stored in the storage device 114. In a typical situation, the remote master sends a data request packet to a network controller 108 of the computing device 100, and the network controller 108 then relays the packet to a CPU 102 via a south bridge 106. The CPU 102 executes some instructions to parse and extract information from the packet and then according to the extracted information, instructs a disk controller 110 to issue appropriate commands to the storage device 114. In response to these commands, the storage device 114 retrieves and sends back the requested data to the computing device 100, which then relays the requested data back to the remote master 118 via the network 116.

As has been shown, the availability of the storage device 114 depends on the availability of the computing device 100. So, if the computing device 100 is powered off, in a hibernating mode, or in any other mode where the computing device 100 stops responding to requests from all remote masters, then the storage device 114 also becomes unavailable to these remote masters. Similarly, if the computing device 100 suffers a catastrophic crash, rendering the computing device 100 non-operational and thus ceasing to respond to data requests, then the storage device 114, even if it is fully operational and functional, still becomes unavailable.

Moreover, in this conventional system, because the requests for data stored in the storage device 114 need to be processed by the computing device 100, the amount of time required to satisfy these requests are unavoidably subject to varying system conditions of the computing device 100. With more and more computationally-intensive applications possibly running on the computing device 100 and exhausting its limited resources, even if the storage device 114 is available and accessible, the effective throughput of the storage device becomes increasingly unpredictable and often times, less than optimal.

As the foregoing illustrates, what is needed in the art is a method and system that is capable of sharing data effectively and reliably and also addressing at least the shortcomings of the prior art approaches set forth above.

### SUMMARY OF THE INVENTION

A method and system for accessing data are disclosed. Specifically, one embodiment of the present invention sets forth a method, which includes the steps of providing a first path for a computing device to direct a first request to access the storage device associated with the computing device, providing a second path for a master to direct a second request to access the storage device based on an operating mode associated with the computing device, and establishing a reliable communication link with the storage device prior to transmitting a command to the storage device.

One advantage of the disclosed method and system is to provide a direct and efficient way to access data and avoid the potential bottleneck resulting from depending on the computing device to process the request for the storage device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a simplified diagram of a conventional computing device that is on a network and also attached to a storage device;

FIG. 2 is a simplified block diagram of a storage manager, supporting multiple modes of accessing a storage device, according to one embodiment of the present invention;

FIG. 3 is a flowchart of the method steps for processing a request to access the storage device in the system configuration of FIG. 2 and in the bypass mode, according to one embodiment of the present invention;

FIG. 4A is a simplified block diagram of a disk bridge, according to one embodiment of the present invention;

FIG. 4B is a simplified block diagram of a disk bridge, according to another embodiment of the present invention;

FIG. 5 is a flowchart of the method steps for processing a request to access the storage device in the system configuration of FIG. 2 and in the bypass mode, according to another embodiment of the present invention;

FIG. 6A is a simplified block diagram of another storage manager, supporting multiple modes of accessing a storage device, according to an alternative embodiment of the present invention; and

FIG. 6B is a simplified block diagram of yet another storage manager, supporting multiple modes of accessing a storage device, according to an alternative embodiment of the present invention.

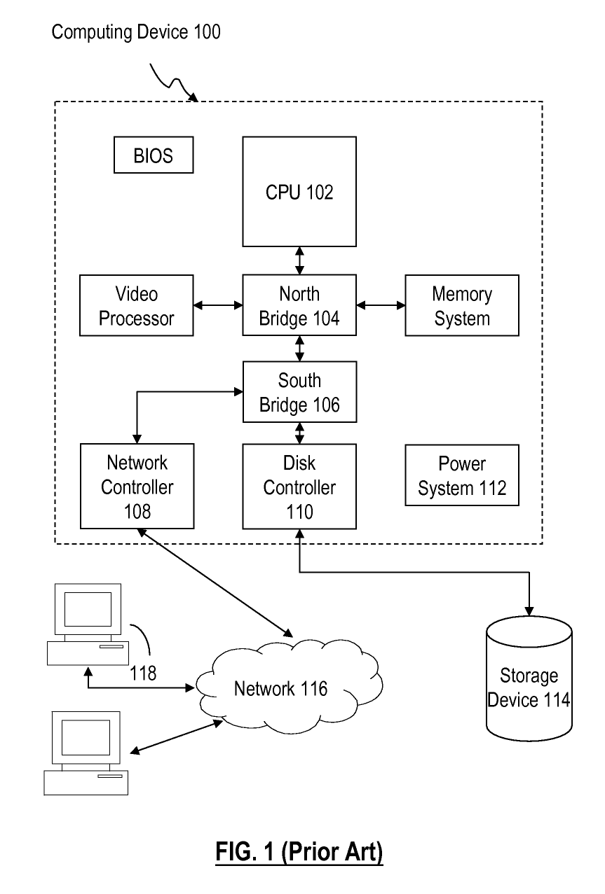

### DETAILED DESCRIPTION

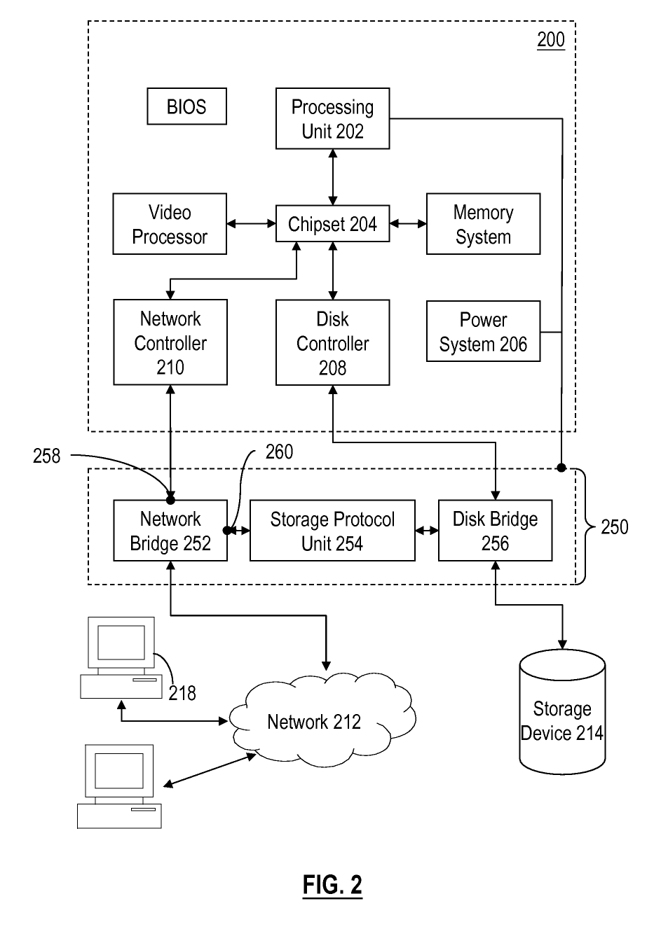

FIG. 2 is a simplified block diagram of a storage manager 250, supporting multiple modes of accessing a storage device 214, according to one embodiment of the present invention. In one implementation, the storage manager 250 includes a network bridge 252, a storage protocol unit 254, and a disk bridge 256. The network bridge 252 is mainly responsible for directing packets to and from a network 212. The storage protocol unit 254, typically supporting multiple storage protocols (e.g., Storage Area Network protocols such as iSCSI, Fibre Channel Protocol, and ATA over Ethernet or Network Attached Storage protocols such as Network File System, Common Internet File System, and File Transfer Protocol) and is mainly responsible for inspecting the content of the received packets and identifying the appropriate commands and data for the storage device 214. The disk bridge 256 is mainly responsible for arbitrating among the requests for the storage device 214 from various masters, such as a remote master 218 and a computing device 200. More importantly, with these three components, the storage manager 250 is capable of handling requests to access the storage device 214 in a stand-alone fashion. In other words, under certain operating modes, the storage manager 250 in effect decouples the dependency between the storage device 214 and the computing device 200 and provides another path to direct access requests to the storage device 214. It is worth noting that the computing device 200 can be any device that the storage device 214 directly attaches to and thus may include more or less components than the ones shown in FIG. 2. Some examples of the computing device 200 include, without limitation, a computer system, a home appliance, and a server system. In addition, it should also be noted that a “storage device” throughout this disclosure broadly refers to, without limitation, (i) non-writable storage media (e.g., read-only memory devices within a computer such as CD-ROM disks readable by a CD-ROM drive, DVD disks readable by a DVD driver, ROM chips or any type of solid-state non-volatile semiconductor memory) on which information is permanently stored; and (ii) writable storage media (e.g., floppy disks within a diskette drive, hard-disk drive, CD-RW, DVD-RW, solid state drive, flash memory, or any type of random-access memory internal or external to the computing device 200 on which alterable information is stored.

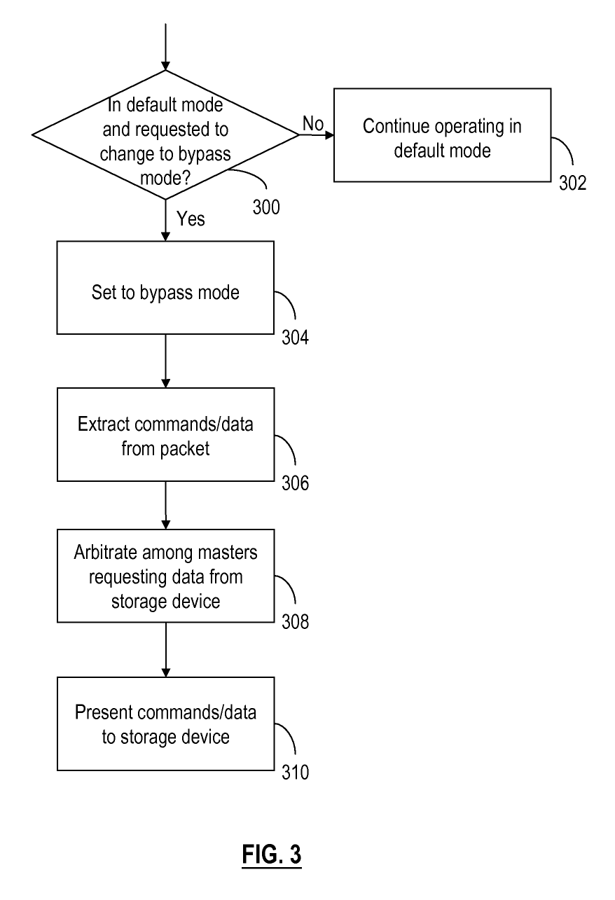

To further demonstrate the various functions of the storage manager 250, FIG. 3 is a flowchart of the method steps for processing a request to access the storage device 214 in the bypass mode and in the system configuration of FIG. 2, according to one embodiment of the present invention. Suppose the storage manager 250 supports three operating modes, a default mode, a bypass mode, and a dual-operating mode. In one implementation, when the storage manager 250 is in the default mode, it directs packets from the network 212 to a processing unit 202 of the computing device 200 for processing and then relays any commands or data from the computing device 200 to the storage device 214 via a disk controller 208. When the storage manager 250 is in the bypass mode, it instead processes packets from the network 212 and bypasses the computing device 200. Further, when the storage manager 250 is in the dual-operating mode, the network bridge 252 within the storage manager 250 forwards network packets to either the computing device 200 or the storage protocol unit 254 based on the contents of these network packets (e.g., the destination addresses in the network packets.) So, in step 300, if the storage manager 250 initially operates in the default mode and receives a request to modify its operating mode, then it proceeds to step 304 and configures its operating mode to either the bypass mode or the dual-operating mode. Otherwise, the storage manager 250 continues to operate in the default mode in step 302. It is worth noting that a number of mechanisms can be deployed to modify the operating mode of the storage manager 250. In one scenario, when the operating system of the computing device 200 encounters certain events, such as, without limitation, receiving a request to shut down, log off, hibernate, or simply direct the network traffic away from the computing device 200, the operating system signals the storage manager 250 to modify the operating mode. In another scenario, when a power system 206 of the computing device 200 detects conditions to power off or to reset, such as, without limitation, mechanically pressing a power-off or reset button, the power system 206 signals the storage manager 250 to modify the operating mode. In this latter scenario, even if the operating system of the computing device 200 suffers an irrecoverable system error, the power system 206 can still independently signal the storage manager 250. In yet another scenario, a remote master may signal the storage manager 250 by sending special commands to it.

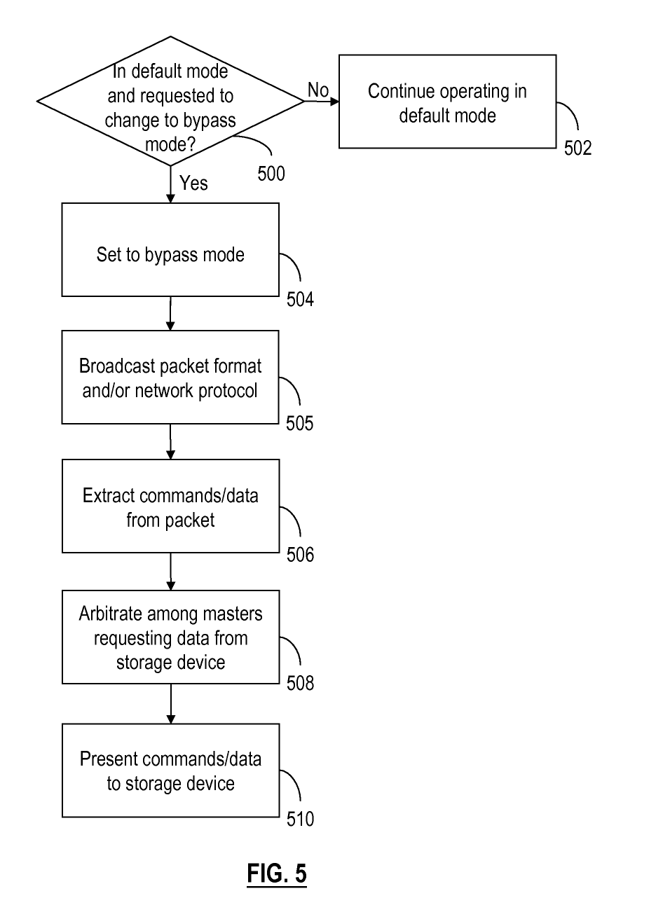

As mentioned above, once in the bypass mode, the storage manager 250 processes all requests to access the storage device 214 from the network 212. More specifically, the network bridge 252 directs the packets received from the network 212 to the storage protocol unit 254 as opposed to a network controller 210 of the computing device 200. In one implementation, the network bridge 252 does not inspect the content of the packets but simply relays the packets to a particular output port, such as either an output port 258 or an output port 260 as shown in FIG. 2, depending on whether the operating mode of the storage manager 250 is in the default mode or in the bypass mode/dual-operating mode, respectively. In another implementation, if the storage manager 250 is in the dual-operating mode, then the network bridge 252 inspects and extracts the contents from the proper fields, such as the destination address (“DA”), of each of the packets and forwards the packets based on the interpretation of such fields. Subsequent paragraphs in conjunction with FIG. 5 will further detail this alternative embodiment.

As long as the packets from the network bridge 252 adhere to one of the protocols supported by the storage protocol unit 254, the storage protocol unit 254 then extracts relevant information from these packets in step 306. Suppose the request from the remote master 218 is to write some data to the storage device 214. Then, after the network bridge 252 directs the one or more packets making up this write request to the storage protocol unit 254, the storage protocol unit 254 extracts the commands corresponding to the write request and also the data intended to be written to the storage device 214 from the packets. If the extracted commands and data are in a data format that is inconsistent with any of the data formats supported by the storage device, then one embodiment of the storage protocol unit 254 discards these invalid packets. On the other hand, if the storage protocol unit 254 determines that the data format of the packets is consistent with one of the data formats supported by the storage device, then the storage protocol unit 254 proceeds to process these valid packets. In one implementation, for efficiency improvement purposes, the storage protocol unit 254 places a number of the valid packets in a buffer so that they can be delivered at once as a large data chunk.

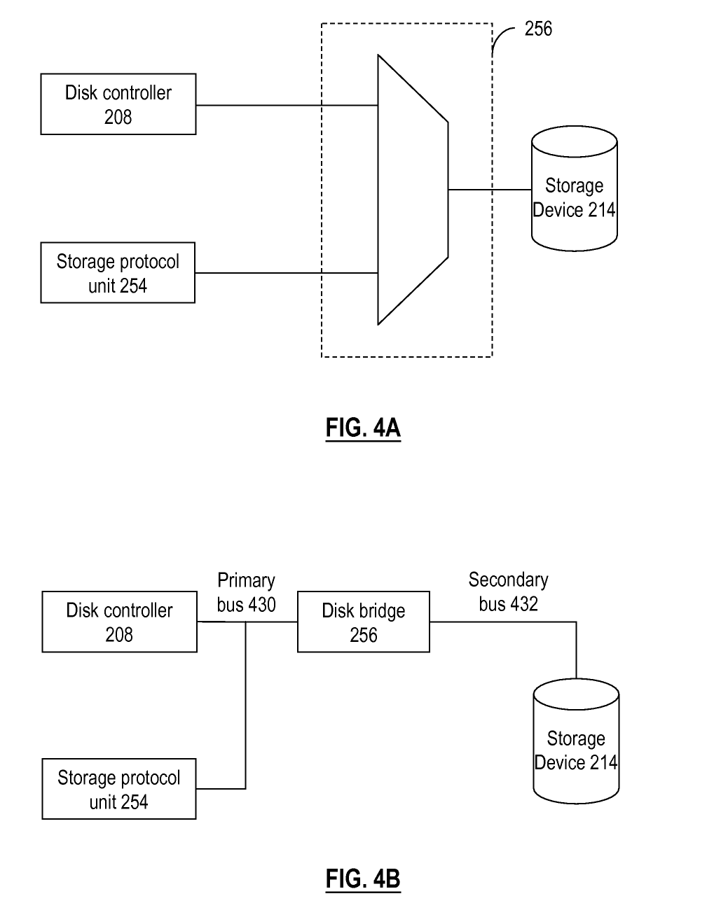

If the storage manager 250 is in the dual-operating mode, then before the storage protocol unit 254 can deliver the extracted commands and data to the storage device 214, the disk bridge 256 arbitrates among all the masters of the storage device 214 to secure a reliable communication link for the storage protocol unit 254 with the storage device 214 in step 308. In one implementation, the disk bridge 256 adopts a port selector 400 as shown in FIG. 4A, where only one of the two masters to the storage device 214 (e.g., the disk controller 208 of the computing device 200 and the storage protocol unit 254 in the system configuration shown in FIG. 2) is activated at a time. So, when the port selector 400 selects the storage protocol unit 254 and activates the port the unit is attached to, the aforementioned reliable communication link is established. In another implementation, the disk bridge 256 adopts the dual-bus architecture as shown in FIG. 4B, where the two masters with unique identification numbers are coupled to a primary bus 430, and the storage device 214 also with an unique identification number is attached to a secondary bus 432. Here, when the storage protocol unit 254 is selected, and its identification number is mapped to the identification number of the storage device 214, the reliable communication link is established. With the reliable communication link, the storage protocol unit 254 proceeds to send the commands and data to the storage device 214 in step 310. In yet another implementation, the disk bridge 256 can simply be a shared bus, coupled with masters and the storage device 214.

It is worth noting here that when the storage manager 250 is in the dual-operating mode, the storage device 214 can potentially respond to requests from both the computing device 200 and a remote master on the network 212 in parallel. In other words, once in the dual-operating mode, any applicable arbitrating schemes for the disk bridge 256, such as the ones described above, enable the computing device 200 to retrieve and playback a first set of data (e.g., a movie file) from the storage device 214 while the remote master 218 also retrieves and edit a second set of data (e.g., an editable document) from the storage device 214.

FIG. 5 is a flowchart of the method steps for processing a request to access the storage device 214 in the dual-operating mode and in the system configuration as shown in FIG. 2, according to another embodiment of the present invention. The method steps shown in FIG. 5 are similar to the method steps shown in FIG. 3 with a few exceptions. More particularly, as mentioned above, in one implementation of the storage manager 250, the network bridge 252 inspects the content of the packets that it receives. So, rather than simply relaying packets to an output port, the network bridge 252 in this implementation extracts and interprets proper fields from each of the packets and forwards the packets according to the results of such interpretation. To inform a remote master on the network 212 the appropriate packet formats or protocols to interact with the storage device 214, one implementation of the storage protocol unit 254 indicates such packet formats or protocols in a broadcast packet for the network bridge 252 to send it to the network 212. This broadcast packet can be generated and sent out any time after the storage manager 250 undergoes a change in its operating mode, such as in step 505. The broadcast packet can also be sent out by the storage protocol unit 254 periodically. To illustrate, suppose the remote master 218 shown in FIG. 2 initially sends requests for the storage device 214 to the DA of the computing device 200, denoted as the DA_{computing device}. Then the remote master 218 receives a broadcast packet indicating a new DA corresponding to the storage protocol unit 254, denoted as the DA_{network storage protocol unit}. Subsequent to the receipt of this broadcast packet, the remote master 218 starts sending requests to access the storage device 214 using the DA_{network storage protocol unit}, not the initial DA_{computing device}.

It should be noted that the computing device 200 and the storage manager 250 may implement different network protocols. To ensure the remote masters on the network 212 are aware of these differences and send packets conforming to the proper network protocol, in one implementation, the broadcast packet containing the address information of the storage protocol unit 254 also includes network protocol information. For example, suppose the computing device 200 implements a network protocol A, and the storage manager 250 implements a network protocol B. Suppose further that the network protocol A and the network protocol B are incompatible to one another. To enable the remote master 218 to switch from sending packets under the network protocol A to the computing device 200 to sending packets under the network protocol B to the storage manager 250, the storage protocol unit 254 causes a broadcast packet with both the new DA and the network protocol B information to be sent to the network 212.

Although a remote master on the network 212 as shown in FIG. 2 can be any device with networking capabilities, such as, without limitation, a mobile device, a handheld device, an Internet appliance, a computer system, and a media playback device, it should be apparent to a person with ordinary skills in the art to incorporate additional functions in the remote master to make use of the multiple operating modes of the storage manager 250 as detailed above. For example, the remote master may include a monitoring function that looks for broadcast packets from the storage manager 250 from time to time. In one implementation, the remote master locally maintains and updates the identification or addressing information associated with the storage manager 250 and compares this information with the source address of each packet it receives. In another example, the remote master may be configured with multiple drivers, each supporting a distinct network protocol. This enables the remote master to flexibly switch from operating under one network protocol to operating under a different network protocol. In yet another example, the remote master supports data recovery applications that not only detect events indicative of the computing device 200 failing to respond to external requests but also provide the remote master with direct accesses to the storage device 214. In one implementation, if the remote master does not receive an acknowledgment to a request for the storage device 214 it sends to the computing device 200 within a certain period of time or after a certain number of attempts, then the remote master sends special commands to the storage manager 250 to activate the bypass mode and gains direct access to the storage device 214.

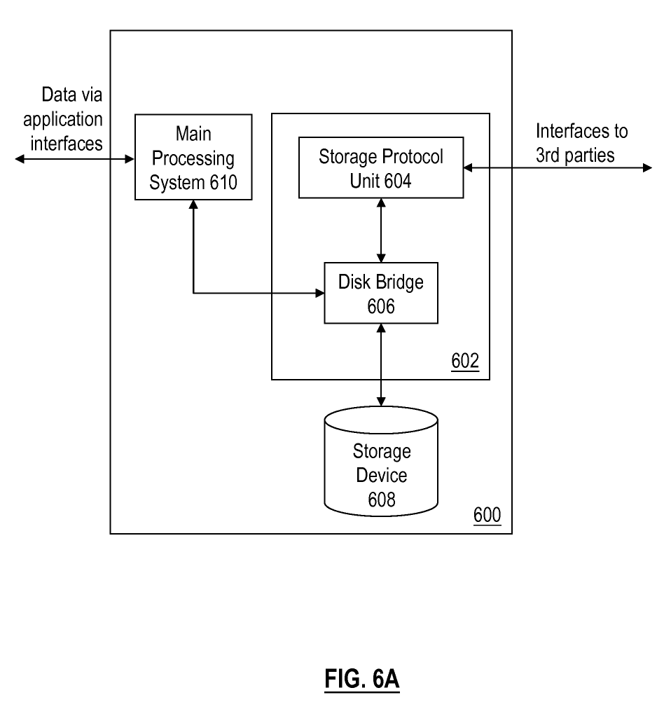

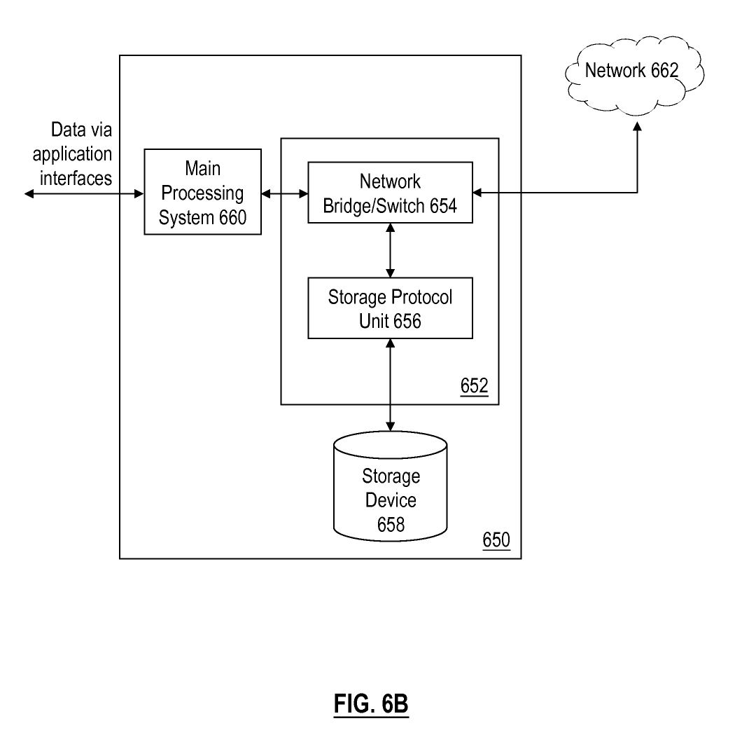

Although the above discussions mainly focus on the system configuration shown in FIG. 2, it should be apparent to an ordinarily skilled artisan to implement the storage manager 250 in other system configuration without exceeding the scope of the claimed invention. For example, FIG. 6A is a simplified block diagram of a storage manager 602 in a home appliance 600, according to an alternative embodiment of the present invention. Here, the home appliance 600 includes a main processing system 610 to process data via various application interfaces (e.g., interfaces to multimedia, gaming, and networking applications) and multimedia data. In addition, the main processing system 610 accesses a storage device 608 via a disk bridge 606 of the storage manager 602. The storage manager 602 also provides another path for a third party to access the storage device 608 via the storage manager 602, even if the main processing system 610 is inactive. In one example, a storage protocol unit 604 in the storage manager 602 supports a number of different interfaces (e.g., network interface, Universal Serial Bus, and others) for a third party to access the storage device 608. In yet another implementation, as shown in FIG. 6B, a storage manager 652 includes a network bridge/switch 654 and a storage protocol unit 656. Here, the main processing system 660 is considered as a client of the storage manager 652 in the same way as any third party on a network 662 attempting to access a storage device 658. Unlike the storage manager 250 of FIG. 2 and the storage manager 602 of FIG. 6A, the storage manager 652 does not have a disk bridging unit, because the network bridge/switch 654 also manages the flow of the incoming requests to access the disk storage 658. It should be noted that the storage device 608 or the storage device 658 can be internal or external to the home appliance 600 and the home appliance 650, respectively.

The above description illustrates various embodiments of the present invention along with examples of how aspects of the present invention may be implemented. The above examples, embodiments, and drawings should not be deemed to be the only embodiments, and are presented to illustrate the flexibility and advantages of the present invention as defined by the following claims.

We claim:

1. A method for accessing data in a storage device associated with a computing device, the method comprises:
providing a first path for the computing device to direct a first request to access the storage device;
providing a second path for a master to direct a second request to access the storage device based on an operating mode associated with the computing device; and
establishing a reliable communication link with the storage device prior to transmitting a command to the storage device.

2. The method of claim 1, further comprising arbitrating between the first request on the first path and the second request on the second path.

3. The method of claim 1, wherein a special command from a network coupled to the computing device sets the operating mode.

4. The method of claim 1, wherein the master directs the second request to the second path without inspecting the content of the second request.

5. The method of claim 1, further comprising:
broadcasting a first address associated with the second path to a network that the computing device is coupled to.

6. The method of claim 5, further comprising:
extracting a destination address from the second request; and
directing the second request to the second path if the destination address matches the first address.

7. The method of claim 5, further comprising:
broadcasting a first storage protocol type associated with the second path to a network that the computing device is coupled to.

8. The method of claim 7, further comprising:
extracting a destination address and a storage protocol type from the second request; and
directing the second request to the second path if the destination address matches the first address and the storage protocol type matches the first storage protocol type.

9. A storage manager for facilitating the accesses of data in a storage device associated with a computing device, wherein the storage manager is configured to:
provide a first path for the computing device to direct a first request to access the storage device;
provide a second path for a master to direct a second request to access the storage device based on an operating mode associated with the computing device; and
establish a reliable communication link with the storage device prior to transmitting a command to the storage device.

10. The storage manager of claim 9, further comprising a disk bridge configured to arbitrate between the first request on the first path and the second request on the second path.

11. The storage manager of claim 9, further comprising a network bridge to receive a special command from a network coupled to the computing device for setting the operating mode.

12. The storage manager of claim 9, further comprising a network bridge to direct the second request to an output port of the network bridge without inspecting the content of the second request, wherein the output port is associated with the second path.

13. The storage manager of claim 9, further comprising a network bridge and a storage protocol unit, wherein the storage protocol unit generates a broadcast packet with a first address associated with the second path for the network bridge to send to a network coupled to the computing device.

14. The storage manager of claim 13, wherein the network bridge is configured to:
extract a destination address from the second request; and
direct the second request to the second path if the destination address matches the first address.

15. The storage manager of claim 13, wherein the storage protocol unit is further configured to include a first storage protocol type associated with the second path in the broadcast packet.

16. The storage manager of claim 15, further wherein the network bridge is configured to:
extract a destination address and a storage protocol type from the second request; and
direct the second request to the second path if the destination address matches the first address and the storage protocol type matches the first storage protocol type.

17. The storage manager of claim 10, wherein the disk bridge further includes a port selector to arbitrate among the masters of the storage device.

18. The storage manager of claim 10, wherein the disk bridge further includes an arbitration logic to arbitrate among the masters of the storage device on a shared-bus.

19. The storage manager of claim 10, wherein the disk bridge is further coupled to a primary bus for the masters of the storage device and a secondary bus for the storage device.

20. A method for recovering data stored in a storage device associated with a computing device, the method comprising:
detecting a state in which the computing device becomes non-operational;
in response to the state, directing a request to access the storage device from a network coupled to the computing device to a path away from the local computing device;
processing the request along the path independently from the computing device to obtain a command for the storage device; and
arbitrating among masters of the storage device to establish a reliable communication link with the storage device for one of the masters prior to transmitting the command to the storage device.

21. A method for enabling a first computing device and a second computing device on a network to access data stored in a storage device associated with the first computing device in parallel, the method comprising:
providing a first path for the first computing device to send a first command to the storage device;
directing a request to access the storage device from the second computing device on the network to a second path;
processing the request along the second path independently from the first path to obtain a second command for the storage device; and
arbitrating among the first computing device and the second computing device to establish a reliable communication link with the storage device prior to transmitting any command to the storage device.
